(19) United States
(12) Patent Application Publication
(10) Pub. No.: US 2004/0039596 A1
(43) Pub. Date: Feb. 26, 2004

(54) Method and system for scheduling and transmitting multiple message types

(75) Inventors: Jay G. Geertsen, American Fork, UT (US); James E. Higgins, Cedar Hills, UT (US); Benjamin D. Kafka, Mapleton, UT (US)

Correspondence Address: Lloyd W. Sadler, Parsons Behle & Latimer, Suite 1800, 201 South Main Street, Salt Lake City, UT, 84111, US

(73) Assignee: Communitect, Inc., Lindon, UT (US)

(21) Appl. No.: 10/645,220

(22) Filed: Aug. 20, 2003

Related U.S. Application Data
(60) Provisional application No. 60/404,861, filed on Aug. 21, 2002.

(51) Int. Cl. G06F 17/60

(52) U.S. Cl. 705/1

(57) ABSTRACT

A method and system for sending scheduling and appointment notification text messages to users based on a device number or address. The method and system determines from the device number or address, service provider specific information which is required when sending various types of messages which dramatically reduces the complexity of administering the system. In addition, the system is very flexible in sending messages at specific intervals and to specific devices to notify the user of an upcoming appointment. This flexibility allows the system to be adapted to the users needs.

### CROSS REFERENCE TO RELATED APPLICATIONS

This application is based on Provisional Patent Application Serial No. 60/404,861, which was filed on Aug. 21, 2002 and priority is hereby claimed thereto.

### BACKGROUND OF INVENTION

1. Field of the Invention

This invention relates to electronic messaging systems. More specifically this invention relates to electronic scheduling and appointment messaging systems.

2. Description of Related Art

A variety of schemes have been used to provide notification to users of appointments. These systems typically will notify the user of an appointment by e-mail or by synthesized audio messages to a phone or voice mail. The messages may be sent manually or are sometimes sent automatically. One feature of these types of systems is that the user may be unaware that he/she has received an e-mail or voice mail message prior to the scheduled appointment, and consequently may not read or listen to the message. In addition, many of these systems lack flexibility for the administrator to determine which type of message to be sent, and how often and when the message is sent. Another drawback of these prior systems is that they typically do not interoperate with various voice/text messaging services with only a telephone number or other type of user information. Generally, service provider specific information must be provided in order to work with specific voice/text messaging services requiring the administrator to have knowledge of the service provider specific information in order to send messages. Although these references may not constitute prior art, the reader is directed for general background material, to the following United States patent and patent application Numbers, each of which is hereby incorporated by reference in its entirety for the material contained therein: U.S. patent and patent application Nos.: 2003/0130870, 2003/0060979, 2003/0005124, 2002/0049733, 2002/0156672, 2002/0143600, 2002/0116232, 2002/0059082, 2002/0049733, 2002/0035605, U.S. Pat. Nos. 6,430,624, 6,345,260, 6,332,157, 6,088,429, 5,872,505, 5,748,907, 5,668,955, 4,769,796.

### SUMMARY OF INVENTION

It is desirable to provide a method and system for dynamically sending various appointment reminders using various text messaging mediums such as e-mail, pagers and cellular devices which make use of various service providers using a single telephone number or other data.

Therefore it is the general object of an embodiment of this invention to provide a method and system for scheduling and transmitting an appointment reminder by getting an item of customer data such as a phone number and determining a specific Local Service Provider or carrier and creating a message that can be sent to the Local Service Provider which in turn is displayed on a messaging device which notifies the customer of a pending appointment.

It is a further object of an embodiment of this invention to provide a method and system where the messaging device is a telephone, a pager, an e-mail system, a hand held computing device, a personal digital assistant and the like.

It is a further object of an embodiment of this invention to provide a method and system where the messages that are sent are an email, a text message, a pager message, and the like.

It is a further object of an embodiment of this invention to provide a method and system where the messages are sent by a rules engine which determines when, how and what types of messages are sent.

It is a further object of an embodiment of this invention to provide a method and system where the messages are sent during specific time periods.

It is a further object of an embodiment of this invention to provide a method and system where the messages are created and sent based on user definable or default templates.

It is a further object of an embodiment of this invention to provide a method and system where the information for the system is stored in a database.

It is a further object of an embodiment of this invention to provide a method and system where the system works over a network such as the Internet.

It is a further object of an embodiment of this invention to provide a method and system where the scheduling of an appointment is done via a Graphical User Interface (GUI) which scheduling automatically generates messages based on configured message templates and scheduling defaults.

It is a further object of an embodiment of this invention to provide a method and system where customer data can be imported into the system and used to generate and schedule messages which are sent to messaging devices.

These and other objects of this invention will be readily apparent to those of ordinary skill in the art upon review of the following drawings, detailed description, and claims. In the preferred embodiment of this invention, the system makes use of a novel system and method of identifying a local service provider gateway based on one or more phone and/or a device numbers and providing service provider specific information which allows access to the service provider gateway, thus removing the complexity for the administrator. In addition, the system and method provide flexibility in allowing an administrator to dynamically schedule when messages will be sent and which types of mediums will be used based on customer needs.

### BRIEF DESCRIPTION OF DRAWINGS

In order to show the manner that the above recited and other advantages and objects of the invention are obtained, a more particular description of the preferred embodiments of this invention, which is illustrated in the appended drawings, is described as follows. The reader should understand that the drawings depict only present preferred and best mode embodiments of the invention, and are not to be considered as limiting in scope. A brief description of the drawings is as follows:

FIG. 1 is a block diagram of the present preferred appointment messaging system.

FIG. 2 is a diagram of the present preferred elements which constitute subscriber data.

FIG. 3 is a flow diagram of the present preferred process for a subscriber to create an appointment for a patient/customer.

FIG. 4 is a flow diagram of the present preferred process for gathering customer/patient information.

FIG. 5 is a flow diagram of the present preferred process for gathering information for messaging devices.

FIG. 6 is a flow diagram of the present preferred process for gathering information to create an appointment.

FIG. 7 is a flow diagram of the present preferred process for importing data from the subscribers practice management system.

FIG. 8 is a continuation of FIG. 7 which is the present preferred process for importing existing data from the subscribers practice management system.

FIG. 9 is a diagram of the present preferred process for defining a message template and modifying it to create a custom text message which is sent to a messaging device.

Reference will now be made in detail to the present preferred embodiment of the invention, examples of which are illustrated in the accompanying drawings.

### DETAILED DESCRIPTION

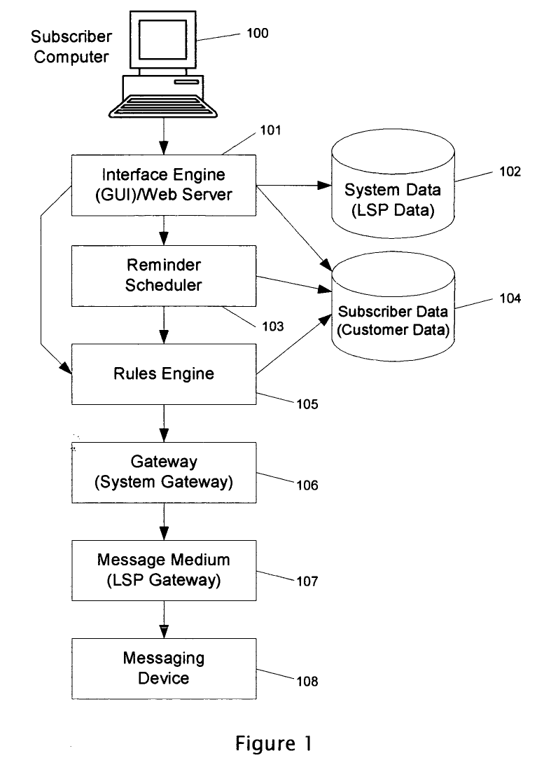

FIG. 1 is a block diagram of the present preferred appointment messaging system. The subscriber computer 100 is where the user (subscriber) gains access to the system. The subscriber computer 100 can be, but is not limited to, a personal computer, a handheld computing device and the like. The subscriber computer 100 communicates with the interface engine 101. The interface engine 101 can be, but is not limited to, a web server, an application, an application server, and the like. The interface engine 101 coupled with the subscriber computer 100 presents the user with information which allows the subscriber to use the system. The system has a database for storing system data 102. System data 102 can include, but is not limited to information pertaining to various wireless and cellular companies or Local Service Providers (LSP) which facilitates the delivery of messages to the Local Service Provider's customers via protocols such as SMTP, SMPP, SNPP, SMS, and the like. System data 102 also includes template information for generating messages which use templates. Subscriber data 104 in the present embodiment contains data about the subscriber, customers (patients/patrons), messaging devices and the like. Subscriber data contains, but is not limited to, information such as customer names, addresses, appointments, patient ID's, chart numbers, preferred names, cell phone numbers, pager numbers and the like. The reminder scheduler 103 takes scheduled appointments from the interface engine 101 and calculates when messages need to be sent based on scheduling information which can correspond to specific time and/or time periods when the messages are to be sent. The rules engine 105 takes the information of when a message needs to be sent and determines which device to send the message to, finds the corresponding Local Service Provider data, and creates the message to be sent. The message is passed to the system gateway 106 which sends the message to the Local Service Provider (LSP) gateway 107 which reads the message and sends the message to the messaging device 108.

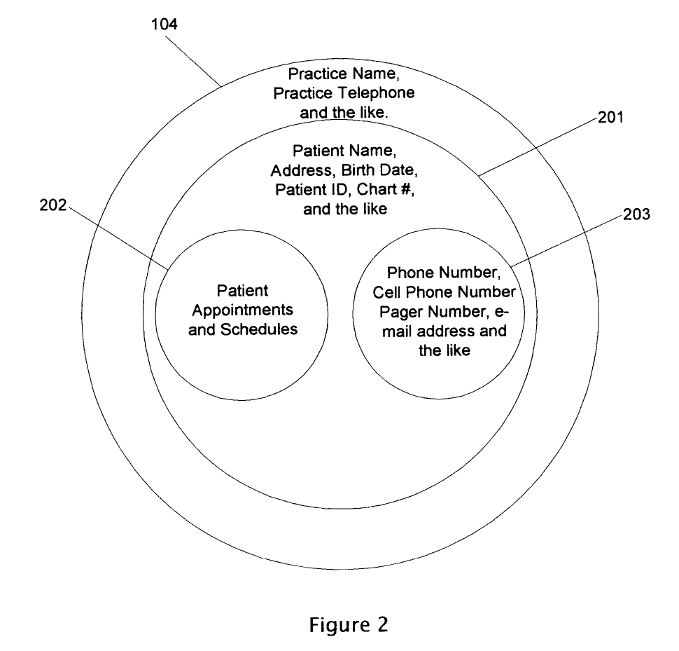

FIG. 2 is a diagram of the present preferred elements which constitute subscriber data. Subscriber data 104 contains information about the practice (business) such as the practice's name, telephone number, fax number, subscriber staff and the like. In addition, subscriber data 104 contains customer data 201 (patient or patron data) such as the patient's name, address, birth date, patient ID, chart number, preferred name and the like. Within customer data 201 is appointment data 202 which is list of any appointments which has been made for the customer. Customer data 201 also contains the customer's device data 203 about each messaging device 108 to which messages can be sent.

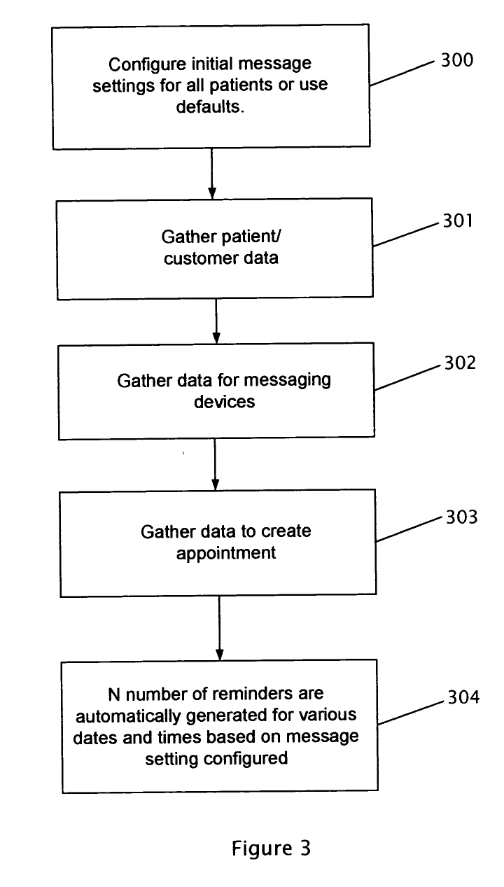

FIG. 3 is a flow diagram of the present preferred process for a subscriber to create an appointment for a patient/customer. The process begins when the initial message settings are configured 300 to customer preferences or the system defaults typically from a graphical user interface which is supplied by a web server (interface engine 101) to a browser on the subscriber computer 100. Customer data 201 is gathered 301 which includes gathering 302 data about the customer's messaging devices 108. Appointment data 202 is gathered 303 so new appointments can be created. A number of reminder messages are automatically generated 304 based on the message settings from step 300, the customer data 201 from step 301, the device data 203 from step 302, and the appointment data 202 from step 303. The message can be sent at specific times leading up to the appointment to notify the customer of a pending appointment on the customer's messaging device 108.

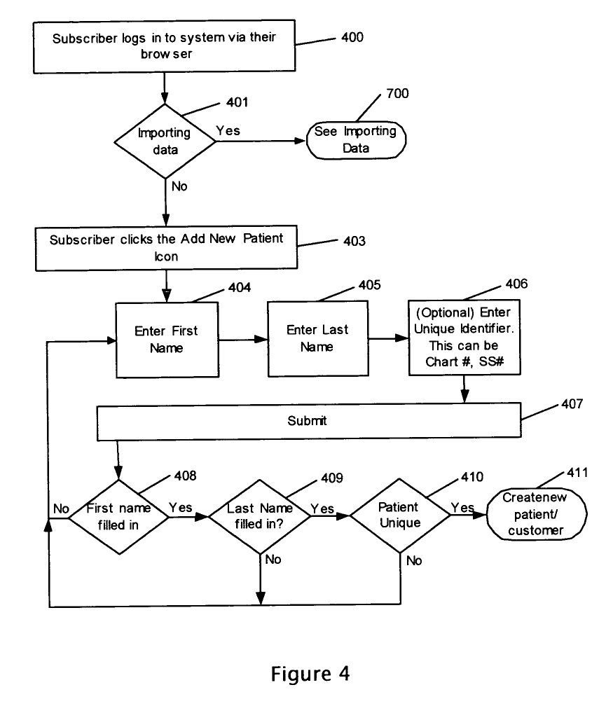

FIG. 4 is a flow diagram of the present preferred process for gathering customer/patient information. FIG. 4 is a detailed view of step 301 in FIG. 3. The process begins when the subscriber logs 400 into the system via the subscriber's browser. The process checks 401 to see if the subscriber wants to import data. If so the process goes to step 700 which is the data importing process. Otherwise, if no data is to be imported, the process flows to step 403. When the subscriber clicks 403 the add new patient icon, the subscriber will enter 404 the customer's first name. The subscriber enters 405 the customer's last name and optionally enters 406 a unique identifier such as a chart number, patient ID, social security number, and the like. The data entered in steps 404, 405, and 406 is submitted 407. The data is checked 408 to see if the first name was filled in. If not, the process waits for the subscriber to complete steps 404, 405, and 406 and resubmit 407 the data. Otherwise, the process checks 409 to see if the last name was filled in. If not, the process waits for the subscriber to complete steps 404, 405, and 406 and resubmit 407 the data. Otherwise the process checks 410 to see if the patient is unique. If not, the process waits for the subscriber to complete steps 404, 405, and 406 and resubmit 407 the data. Otherwise, the process creates 411 a new customer/patient.

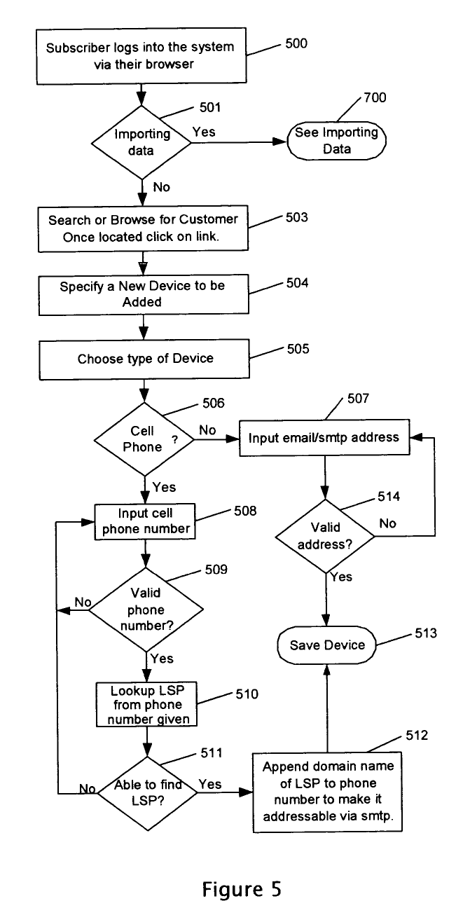

FIG. 5 is a flow diagram of the present preferred process for gathering information for messaging devices. FIG. 5 is a detailed view of step 302 in FIG. 3. The process begins when the subscriber logs 500 into the system via the subscriber's browser. The process checks 501 to see if the subscriber wants to import data. If so the process goes to step 700 which is the data importing process. Otherwise, if no data is to be imported, the process flows to step 503. The subscriber searches 503 for a customer/patient and clicks on the link. The subscriber specifies 504 that a new device should be added. The subscriber chooses 505 the type of device. If in test 506 the device is not a cell phone, the subscriber inputs 507 the e-mail/SMTP address. The process checks 514 to see if the e-mail/SMTP address is valid. If the e-mail/SMTP address is not valid the subscriber must input 507 the e-mail/SMTP address again. Otherwise, the device and the device's information are saved 513 which complete the process. If in test 506 the device is a cell phone, the subscriber inputs 508 the cell phone number. The process checks 509 to see if the cell phone number is valid by checking for the correct number of digits (which may vary depending on the messaging device 108), non-numeric characters, and the like. If not, the subscriber inputs 508 the cell phone number again. Otherwise, the process looks up 510 the Local Service Provider (carrier) for the cell phone number entered in step 508. If the process is able to find 511 a Local Service Provider, the process appends 512 a domain name of the Local Service Provider to the phone number to make it addressable via SMTP. The device and the device's information are saved 513 which complete the process. Otherwise, if a Local Service Provider is not found in test 511, the subscriber inputs 508 the cell phone number again.

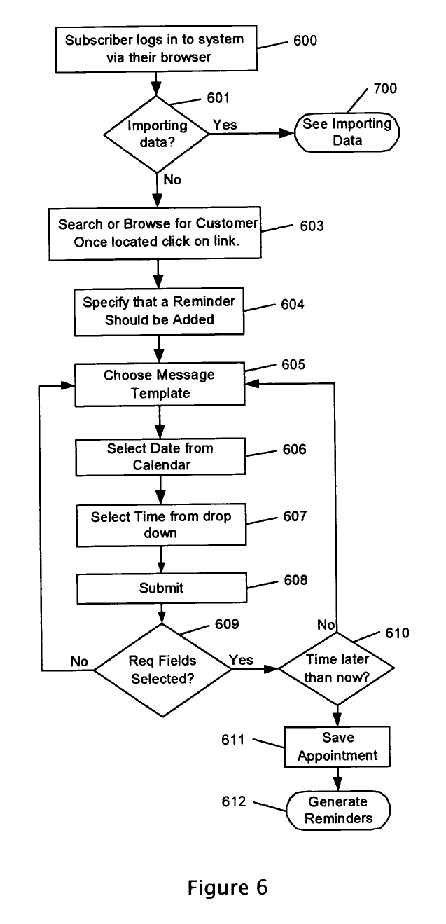

FIG. 6 is a flow diagram of the present preferred process for gathering information to create an appointment. FIG. 6 is a detailed view of step 303 in FIG. 3. The process begins when the subscriber logs 600 into the system via the subscriber's browser. The process checks 601 to see if the subscriber wants to import data. If so the process goes to step 700 which is the data importing process. Otherwise, if no data is to be imported, the process flows to step 603. The subscriber searches 603 for a patient/customer and clicks on the link. The subscriber specifies 604 that a reminder should be added. The subscriber chooses 605 a message template. The subscriber selects 606 a date from the calendar. The subscriber selects 607 a time from the drop down menu. The subscriber submits 608 the data collected in steps 605, 606, and 607. If in test 609 any of the required fields were not selected, the subscriber must select the correct data in steps 605, 606, and 607 before resubmitting 608 the data. Otherwise, the process checks to see if the appointment time is later than the time is now. If the appointment time is not later than now, the subscriber will have to select a correct time from step 607 and resubmit 608 the data. Otherwise, the appointment is saved 611 and the system generates 612 reminders.

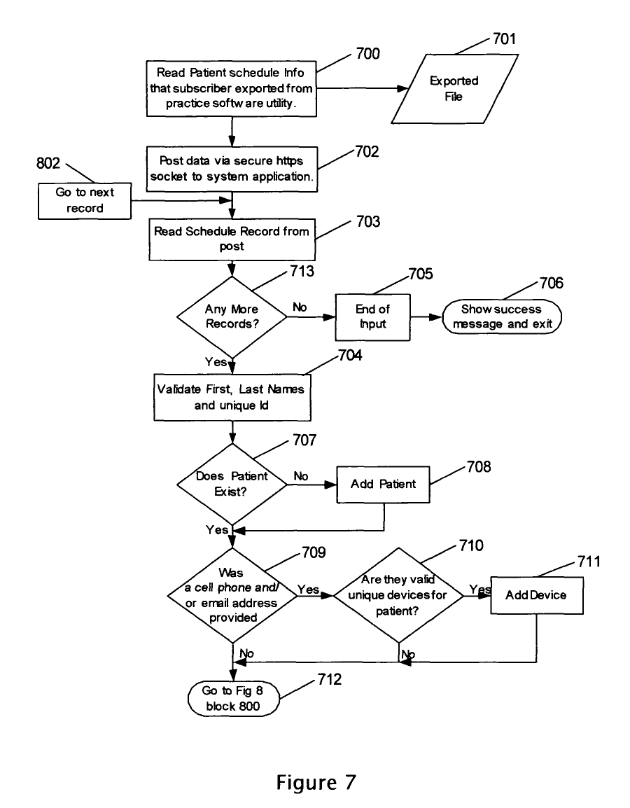

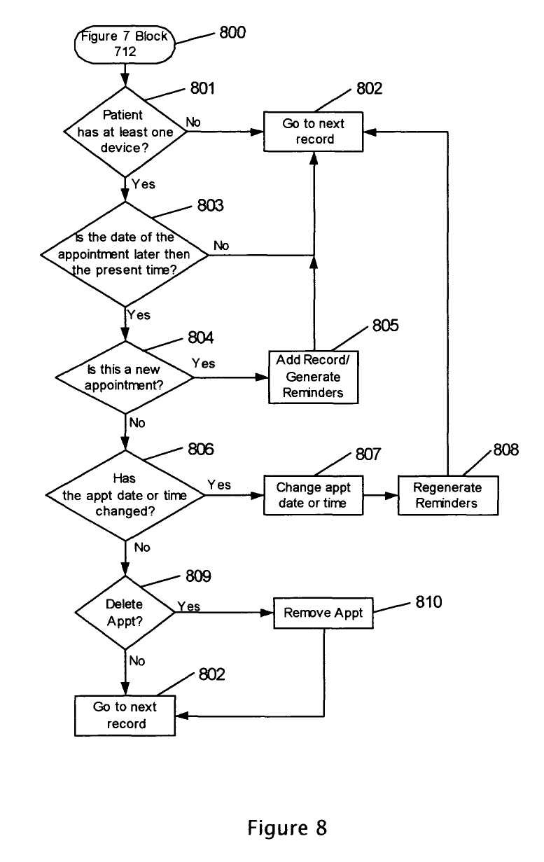

FIGS. 7 and 8 are flow diagrams of the present preferred process for importing existing data from the subscriber's practice management system. The subscriber's practice management system contains customer data 201 that needs to be read into the system. The process begins when the exported file 701 which contains patient/customer schedule data which has been exported from a practice software utility. The exported file 701 contains customer data. The data is read 700 into the system. The data is posted 702 via a secure https socket to the system application. The preferred embodiment uses https, but other protocols can be used. The process reads 703 a scheduled record from the post. The process checks 713 to see if there are any more records. If not, this signifies the end 705 of input and the process shows 706 a success message and exits. Otherwise, the process validates 704 the first name, the last name and the unique identifier. The process checks 707 to see if the patient already exists. If not, the patient is added 708. The process checks 709 to see if a cell phone, pager, personal digital assistant, e-mail address or the like was provided. If so, the process checks 710 to see if the devices are valid and unique for the patient. If the devices are unique, each device is added 711 and the process goes to step 712 which is FIG. 8 block 800. If the device is not unique in test 710, the process goes to step 712 which is FIG. 8 block 800. If a cell phone or e-mail address was not provided in test 709, the process also goes to step 712 which is FIG. 8 block 800. Step 800 flows to test 801 which checks to see if the customer/patient had at least one device. If not, the process goes to step 802 which gets the next record. Step 802 flows to step 703 where the next record is read from the post. Otherwise, if there is at least one device in test 801, the process checks 803 to see if an appointment is later than the present time. If the appointment is not later than the present time, the process goes to step 802 which gets the next record. Step 802 flows to step 703 where the next record is read from the post. Otherwise, if the date is later than the present time in test 803, the process checks 804 to see if the appointment is a new appointment. If it is a new appointment, a new appointment is added 805 along with the generation of the appointment's reminders. The process goes to step 802 which gets the next record. Step 802 flows to step 703 where the next record is read from the post. If the appointment is not a new appointment in test 804, the process checks 806 to see if the appointment time or date has changed. If so, the appointment time or date is changed 807, reminders are regenerated 808 and the process goes to step 802 which gets the next record. Step 802 flows to step 703 where the next record is read from the post. If test 806 is no, the process determines whether to delete 809 the appointment. If so, the process removes 810 the appointment. The process goes to step 802 which gets the next record. Step 802 flows to step 703 where the next record is read from the post.

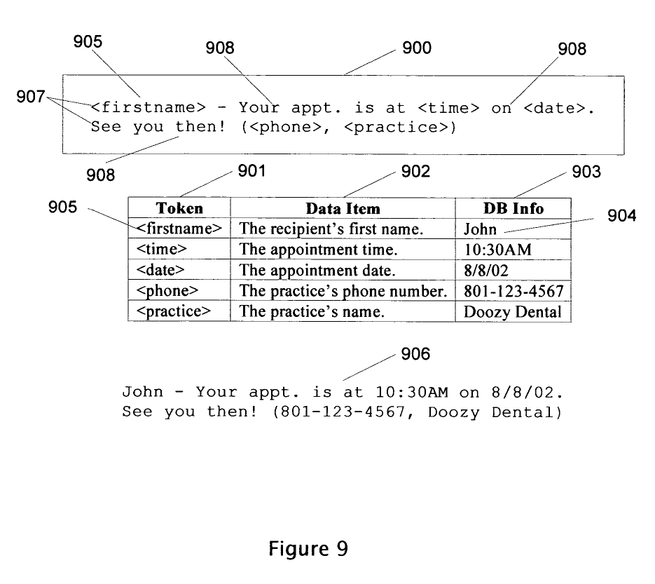

FIG. 9 is a diagram of the present preferred process for defining a message template and modifying it to create a custom text message which is sent to a messaging device. The subscriber is presented in a Graphical User Interface 900 a template 907 which contains tokens 905 and non-tokens 908. The template has tokens 901 such as the first name 905 which is the first name of the customer. The token is stored in a database 903 which has the actual name 904 of the customer. The subscriber modifies the non-token sections 908 of the template 907 and/or the subscriber can add or delete tokens 901. When the message is generated the tokens 901 are replaced with the data base information 903 to generate the text portion 906 of the message that is sent and displayed on the messaging device 108.

In addition, these messaging systems and methods can be implemented using a variety of process, but are not limited to computer hardware, microcode, firmware, software, and the like.

The methods and system described can be used in a variety of business that schedule appointments with notifications such as dental, medical, law firms, auto repair, and the like.

The described embodiments of this invention are to be considered in all respects only as illustrative and not as restrictive. Although specific flow diagrams and templates formats are provided, the invention is not limited thereto. The scope of this invention is, therefore, indicated by the claims rather than the foregoing description. All changes, which come within the meaning and range of equivalency of the claims, are to be embraced within their scope.

1. A method for sending service provider specific messages comprising:
A. scheduling an appointment in a reminder scheduler;
B. getting one or more items of customer data associated with said appointment;
C. retrieving one or more items of local service provider data based on said one or more items of customer data;
D. creating a message in said reminder scheduler using said one or more items of local service provider data and said one or more items of customer data;
E. determining from said one or more items of customer data and said one or more items of system data a local service provider gateway; and
F. sending said message based on said appointment to a said local service provider gateway.

2. A method for sending service provider specific messages as recited in claim 1, further comprising the step of sending said message from said local service provider gateway to a messaging device.

3. A method for sending service provider specific messages as recited in claim 2, wherein said messaging device is selected from the group consisting of a telephone, a pager, and an e-mail system.

4. A method for sending service provider specific messages as recited in claim 1, wherein said message is selected from the group consisting of a text message, an e-mail message, and a pager message.

5. A method for sending service provider specific messages as recited in claim 1, wherein at least one of said one or more items of customer data is a telephone number.

6. A method for sending service provider specific messages as recited in claim 1 wherein generating said message is based on a rules engine.

7. A method for sending service provider specific messages as recited in claim 1 wherein said messages are sent at configurable times.

8. A method for sending service provider specific messages as recited in claim 1 wherein creating said message is based on a template.

9. A method for sending service provider specific messages as recited in claim 1 wherein sending said message is based on a template.

10. A method for sending service provider specific messages as recited in claim 1 wherein said one or more items of subscriber data is in a database.

11. A method for sending service provider specific messages as recited in claim 1 wherein said messages are sent over a network.

12. A method for sending service provider specific messages as recited in claim 11 wherein said network is the Internet.

13. A method for sending service provider specific messages as recited in claim 1 further comprising the step of scheduling an appointment on a Graphical User Interface.

14. A method for sending service provider specific messages as recited in claim 1 further comprising the step of importing said customer data from a practice management system.

15. A system for sending service provider specific messages comprising:
A. a reminder scheduler;
B. a local service provider gateway;
C. a system gateway;
D. wherein an appointment is made in said reminder scheduler; and
E. wherein said reminder scheduler notifies said system gateway of the need to send a message; and
F. wherein said system gateway takes one or more items of customer data associated with said appointment and one or more items local service provider information to create said message; and
G. wherein said message is sent to said local service provider gateway.

16. A system for sending service provider specific messages as recited in claim 15, wherein said service provider gateway sends said message to a messaging device.

17. A system for sending service provider specific messages as recited in claim 16, wherein said messaging device is selected from the group consisting of a telephone, a pager, and an e-mail system.

18. A system for sending service provider specific messages as recited in claim 15, wherein said message is selected from the group consisting of a text message, an e-mail message, and a pager message.

19. A system for sending service provider specific messages as recited in claim 15, wherein at least one of said one or more items of customer data is a telephone number.

20. A system for sending service provider specific messages as recited in claim 15 wherein notifying said system gateway of the need to send a message is based on a rules engine.

21. A system for sending service provider specific messages as recited in claim 15 wherein said messages are sent at configurable times.

22. A system for sending service provider specific messages as recited in claim 15 wherein creating said message is based on a template.

23. A system for sending service provider specific messages as recited in claim 15 wherein sending said message is based on a template.

24. A system for sending service provider specific messages as recited in claim 15 wherein said subscriber data is in a database.

25. A system for sending service provider specific messages as recited in claim 15 wherein said messages are sent over a network.

26. A system for sending service provider specific messages as recited in claim 25 wherein said network is the Internet.

27. A system for sending service provider specific messages as recited in claim 15 further comprising a Graphical User Interface for scheduling said appointments.

28. A system for sending service provider specific messages as recited in claim 15 wherein said customer data is imported from a practice management system.
